(19) United States
(12) Patent Application Publication
(10) Pub. No.: US 2008/0022577 A1
(43) Pub. Date: Jan. 31, 2008

(54) FISH BITE DETECTOR

(76) Inventor: Michael Duggins, Galatia, IL (US)

Correspondence Address: C RICHARD MARTIN;MARTIN & MARTIN, ATTORNEYS AT LAW, PC, PO BOX 29, BOONVILLE, IN, 47601, US

(21) Appl. No.: 11/309,317

(22) Filed: Jul. 26, 2006

(51) Int. Cl. A01K 97/12

(52) U.S. Cl. 43/17

(57) ABSTRACT

A fish bite detector for use on flexible fishing rods to detect and notify the angler that a fish is biting at the bait located at the end of his fishing line. The fish bite detector comprises a first component part configured to be removably placed over an end of a fishing pole and line, a second component part configured to be removably anchored to a fixed surface or object, and line means for flexibly connecting the first component part to the second component part. Line storage means affixed to one of the first or second component parts are also provided. The line storage is preferably affixed to the closed end of the cylindrical body of the first component part.

### BACKGROUND OF THE INVENTION

The present invention relates generally to fish bite detectors for use on fishing rods commonly utilized in fishing with rod and reel combinations. Fish bite detectors are well known devices used to give an angler warning that a fish is taking the bait so that he is ready to strike the hook home at the desired time.

The most common bite detectors used are simple devices that clip onto the tip of the fishing rod, such as bells and the like, which rattle when the tip of the rod is jerked suddenly by a biting fish. The main drawback of these types of clip-on sounders is that they have to be fitted to the tip of the rod after every cast and removed again before an angler can strike at a biting fish. If the device is not removed before a strike, then the device usually flies off the tip of the rod behind the angler and causes the line to tangle around the device spelling disaster and mayhem for the angler. Having to remove the device each time before striking usually means that by the time the rod is lowered and the device is removed, the fish is long gone.

### SUMMARY OF INVENTION

The invention provides a fish bite detector comprising a first component part configured to be removably placed over an end of a fishing pole and line, a second component part configured to be removably anchored to a fixed surface or object, and line means for flexibly connecting the first component part to the second component part.

The first component part comprises a cylindrical body having a first closed end and a second open end for receiving the fishing pole end and line. The first component part may further include visual signaling means. The visual signaling means may take the form of a coating of fluorescent material on the outer surface of the first component part, or the first component part may be formed of fluorescent material.

The second component part comprises a weighted anchor, which may take the form of a cylindrical body having a first closed end and a second open end. The cylindrical body thereof is partially filled with weighted material. The diameter of the open end of the second component part is slightly greater than the diameter of the closed end of the first component part. A projection extends from one of either the outer surface of the closed end of the first component part or the inner surface of the second component part, and a corresponding opening is provided on the other of the outer surface of the closed end of the first component part or the inner surface of the second component part. The opening is configured to receive the projection in frictional engagement therewith.

The fish bite detector may further include line storage means affixed to one of the first or second component parts. The line storage is preferably affixed to the closed end of the cylindrical body of the first component part.

Accordingly, the primary objective of the present invention is to provide a lightweight, durable and effective device for detecting when a fish bites the bait at the end of the fishing line and for notifying the angler of that fish bite. It is also an important objective of the present invention to provide a fish bite detector that is relatively inexpensive to make and simple to use.

These and other objects, features, aspects and advantages of the present invention will become better understood by referring to the following detailed description, drawings and claims, wherein examples of the presently preferred embodiments are given for purposes of illustration and disclosure.

### BRIEF DESCRIPTION OF THE DRAWINGS

The invention will be better understood and objects other than those set forth above will become apparent when consideration is given to the following detailed description thereof. Such description makes reference to the drawings wherein:

FIG. 1 is a perspective view of a fishing rod in combination with the fish bite detector of the present invention.

FIG. 2 is a side view in elevation of the fish bite detector of the present invention in a stowed condition.

### DETAILED DESCRIPTION OF THE PREFERRED EMBODIMENTS

With reference now to the drawings, a preferred embodiment of the fish bite detector 10 embodying the principles and concepts of the present invention will be described. In its broadest context, the fish bite detector 10 includes a first component part 20, second component part 30, and connecting line means 40.

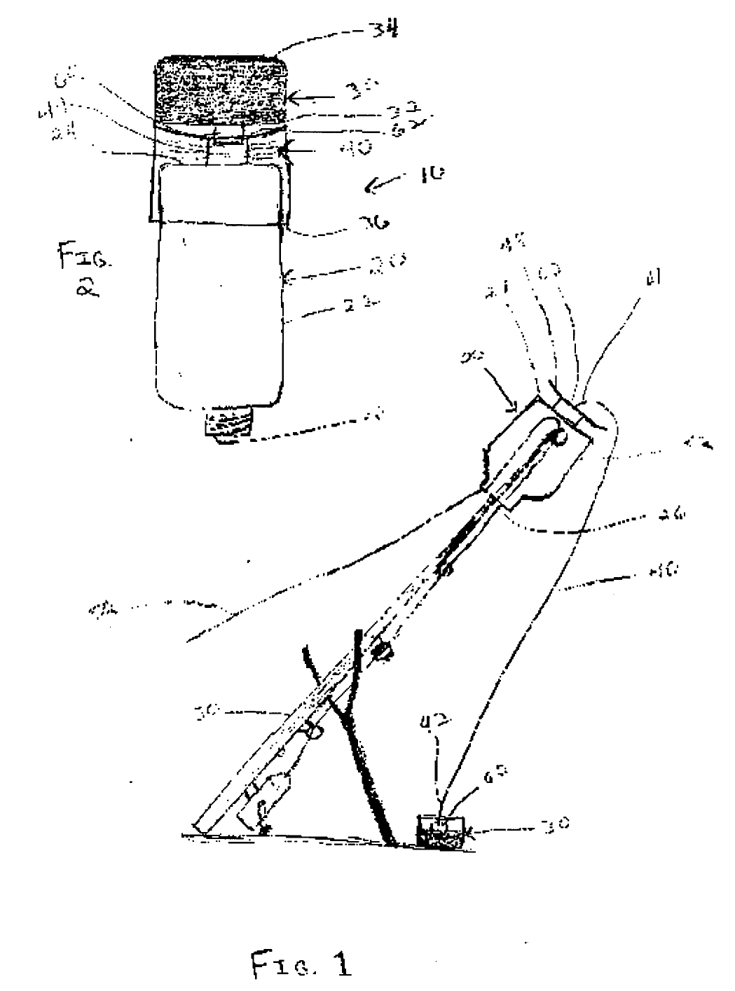

As shown in FIG. 1, in use, the first component part 20 is configured to be removably placed over an end of a fishing pole 50 and line 52. The fish bite detector 10 comprises a cylindrical body 22 having a first closed end 24 and a second open end 26 for receiving the end of the fishing pole 50 and line 52. The profile of the second open end 26 may be tapered as shown in FIGS. 1 and 2, or it may be straight. The first component part 20 of the fish bite detector 10 may also include visual signaling means to allow the angler to better see the action of the first component part in low lighting conditions or at night. According to a preferred embodiment, the outer surface of the first component part 10 is coated with a fluorescent material that glows in the dark or is otherwise visible in darkness. It is contemplated that other visual signaling means, such as lights, LED diodes and the like may also be utilized.

The second component part 30 is connected to the first component part 20 by line means 40 and is configured to be removably anchored to a fixed surface or object. According to the preferred embodiment shown in FIGS. 1 and 2, the second component part 30 comprises a cylindrical body 32 having a first closed end 34 and a second open end 36. The cylindrical body 32 is partially filled with weighted material 38, such as lead, sand, metal or the like. As shown in FIG. 2, the diameter of the second component part open end 36 is slightly greater than the diameter of the first component part closed end 24 in order to permit nesting of the first component part in the second component part for storage of the fish bite detector when not in use.

The connecting line means 40 comprises a flexible rope, wire or line having a first end 41 connected to the first component part 20 and a second end 42 connected to said second component part 30. Means are also provided for storing the line 40 when the detector 10 is not in use, as shown in FIG. 1. According to the preferred embodiment, the line storage means includes a spool 44 affixed to the outer surface of the closed end 24 of the first component part 20. Alternatively, the spool 44 may be affixed to the inside of the second component part 30.

The fish bite detector 10 further includes a projection 60 extending from the inner surface of the second component part 30, and a corresponding opening 62 on the outer surface of the spool 44 on the closed end 24 of the first component part 20. The opening 62 is configured to receive the projection 60 in frictional engagement therewith to secure the first component part 20 and second component part 30 to one another when the detector is in the stowed configuration as shown in FIG. 2. Alternatively, the projection 60 may be located on the outer surface of the closed end 24 of the first component part 20, and the opening 62 located on the inner surface of the second component part 30.

In operation, once the fishing pole 50 is placed in its holder, the angler removes the first component part 20 from the second component part 30 and unfurls a length of line 40 from the spool 44. The second component part 30, with its weighted insert 38 is then placed on a solid surface such as the ground or dock. The end of the fishing pole 50 and the line 52 extending there from are then inserted into the open end 26 of the first component part 20 until the end of the fishing pole touches the inner surface of the closed end of the first component 20. In the configuration, as shown in FIG. 1, the line 52 is deflected from its original position to run parallel to the length of the fishing pole 50. When a fish bites the bait on the end of the line 52, the line is pulled tight, causing the first component part 20 to fly off the end of the fishing pole 52. The fluorescent color of the first component part 20 makes it easier for the angler to see this activity, even in darkness. Further, when the first component part 20 flies off the end of the fishing poles it makes a whooshing sound which further alerts the angler that a fish is on the line. The angler may then pick up the fishing pole 50, hook and reel in the fish without any interference from the fish bite detector which has been removed from the fishing pole. After the fish is secured, the angler may then use the line 40 to retrieve the first component part 20.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed is:

1. A fish bite detector comprising:
a first component part configured to be removably placed over an end of a fishing pole and line;
a second component part configured to be removably anchored to a fixed surface or object; and
line means for flexibly connecting said first component part to said second component part.

2. The fish bite detector of claim 1, further comprising line storage means affixed to one of said first or second component parts.

3. The fish bite detector of claim 2, wherein the first component part comprises a cylindrical body having a first closed end and a second open end for receiving the fishing pole end and line.

4. The fish bite detector of claim 3, wherein the line storage means is affixed to the closed end of the cylindrical body.

5. The fish bite detector of claim 3, wherein the second component part comprises a cylindrical body having a first closed end and a second open end, and wherein the cylindrical body is partially filled with weighted material.

6. The fish bite detector of claim 5, wherein the diameter of the open end of the second component part is slightly greater than the diameter of the closed end of the first component part.

7. The fish bite detector of claim 6, further comprising a projection extending from one of either the outer surface of the closed end of the first component part or the inner surface of the second component part, and a corresponding opening on the other of the outer surface of the closed end of the first component part or the inner surface of the second component part, said opening configured to receive the projection in frictional engagement therewith.

8. The fish bite detector of claim 1, wherein the first component part includes visual signaling means.

9. The fish bite detector of claim 8, wherein the outer surface of the first component part is coated with a fluorescent material.

10. The fish bite detector of claim 1, wherein the second component part comprises a weighted anchor.
